(19) United States
(12) Patent Application Publication
(10) Pub. No.: US 2012/0177747 A1
(43) Pub. Date: Jul. 12, 2012

(54) Compositions and Methods for Treating Lameness in Hoofed Domesticated Animals Due to Hairy Foot Warts and Foot Rot

(75) Inventors: Burt R. Sookram, Palm Harbor, FL (US); John W. Veenstra, Frisco, TX (US)

(73) Assignee: NOBLE ION, LLC, Frisco, TX (US)

(21) Appl. No.: 13/346,544

(22) Filed: Jan. 9, 2012

Related U.S. Application Data
(60) Provisional application No. 61/431,026, filed on Jan. 9, 2011.

(51) Int. Cl. A01N 59/16; A01N 59/20; A01P 15/00

(52) U.S. Cl. 424/637; 424/638; 424/641

(57) ABSTRACT

Compositions and methods for preventing or controlling lameness in domesticated hoofed animals due to hairy foot warts and foot rot comprising a biocidal system comprised of a primary biocide and a secondary biocide; a pH buffer agent; a surfactant; all in an aqueous based carrier.

### RELATED U.S. APPLICATIONS

This application claims priority to U.S. Provisional Application No. 61/431,026 filed Jan. 9, 2011, the entire disclosure of which is incorporated herein by reference. U.S. patent application Ser. No. 13/295,882 entitled “Compositions for Treating Mastitis,” which is incorporated by reference herein in its entirety, and a U.S. patent application entitled “Compositions and Method of Use for Treating Lameness in Hoofed Domesticated Animals Due to Hairy Foot Warts and Foot Rot,” which is also incorporated by reference herein it its entirety, filed contemporaneously with this application.

### FIELD OF THE INVENTION

The present disclosure relates to compositions and methods that are effective in controlling and preventing lameness due to Digital Dermatitis (hairy warts) and Interdigital Necrobacillosis (foot rot) in hoofed domesticated animals.

### BACKGROUND OF THE INVENTION

Lameness in hoofed animals can be traced back to one or a combination of ailments such as Hard and Soft feet, Interdigital Necrobacillosis (foot rot), Interdigital Dermatitis, Digital Dermatitis (hairy warts), Laminitis and Sole ulcers.

Lameness related to digital diseases are mainly categorized as either infectious diseases in the softer tissues (skin and inter-digital tissue) or diseases in the horn capsule related to laminitis (sole ulcer, sole hemorrhages, white line disease and double sole). The most common lesions detected in acute lameness are:
a) sole ulcer,
b) white line abscess,
c) digital dermatitis (papillomatous digital dermatitis, hairy foot warts, Mortellaro disease),
d) inter-digital phlegmon (foot rot, interdigital necrobacillosis),
e) inter-digital dermatitis and heel horn erosion (in most cases sub-clinical hoof lesions),
f) laminitis (sole lesions, i.e. sole- and white line hemorrhages, double sole, and fissure of the white line).

Digital dermatitis is commonly referred to as “hairy foot warts” but there are other names such as hairy heel warts, digital warts, strawberry foot, raspberry heel, interdigital papillomatosis, or papillomatous digital dermatitis. As the name indicates, hairy foot warts are actual warts with hair (see FIG. 1). Regular warts are caused by viruses but hairy foot warts are caused by a bacterial infection. Evidence suggests that the cause of hairy foot warts is the spirochete of the genus Treponemais. Hairy foot warts were first described in Europe in the mid 1970's and in the Unites States in the mid 1980's. By the early 1990's, many North American dairies had one or more cows afflicted with hairy foot warts. The origin of hairy foot warts in the United States is unknown. Factors that contribute to the rapid spread of this disease across the USA are believed to be the sale and purchase of cattle, dairy shows, hoof trimmers, nutritionists, veterinarians and any number of other farm visitors. The disease is prevalent in adult dairy cattle housed in confinement facilities, less prevalent in dairy cattle that are pastured and even less prevalent in beef cattle. Hairy foot warts have been diagnosed in cattle as early as 6 months of age.

Foot rot is caused by a combination of the bacteria Fusobacterium necrophorum and Dichelobacter (formally Bacteroides) nodosus and Bacteroides melaminogenicus. Fusobacterium necrophorum is a normal inhabitant of an animal's ruminant digestive tract and may survive in soil for up to ten months. It produces a leukocidal exotoxin that reduces the protective white blood cells from ingesting bacteria (phagocytosis) and causes supportive necrosis. Bacteroides melaminogenicus produces proteases that damage the subcutaneous tissue and tendons. Dichelobacter nodosus can survive a maximum of two weeks in the environment. It produces an enzyme capable of digesting the connective tissue between the horn and flesh of the hoof, thereby allowing migration to areas under the horn. If foot rot is not controlled it may invade deeper structures of the foot, including joints which may lead to septic arthritis. Foot rot tends to be seasonal with the highest incidence occurring during the wet seasons. Bacteria cannot by themselves gain entry to the skin and cause foot rot. Cuts, bruises, puncture wounds, or severe abrasions of the foot due to sharp rocks, sticks, or frozen mud/ice will damage the skin in the interdigital space and predispose an animal to foot rot by allowing bacteria to invade and multiply within the tissue. Lameness is typically followed by reddening of the interdigital tissue and swelling of the foot causing spreading of the toes. One or more feet may be affected simultaneously. Foot rot is typically diagnosed by distinctive lesions and odor.

Laminitis is an inflammation of the sensitive tissues of the foot lying immediately under the horn of the hoof. It is recognizable by paring the sole of the foot, yellow discoloration, blood spots in the sole, erosion of the heel and sole abscesses known as under-running of the sole. In chronic cases there is unevenness with raised rings around the hoof wall, uneven growth of the hoof and elongation of the toe leading to “ski” or “skid” foot. The cause is mainly nutritional especially rumen acidosis. The genetic makeup of an animal's hooves and legs is also of crucial importance for dairy production and longevity of the cow.

When lameness appears among several cows in the herd it is considered to be a herd health problem. Because it is difficult to examine an animal's hooves for diagnostics, preventative measures will most often not be initiated on a timely basis. Fertility is heavily affected by lameness. The risk for premature culling is also significantly higher among lame cows. A lame cow loses her rank in the herd and changes her eating behavior. The resulting negative energy balance impairs milk production and body condition. In such cases, milk yields decrease two weeks before lameness is clinically observed. It has also been shown that lame cows lie down more than healthy cows and thus have a higher risk for leg injuries. Other complications of lameness, such as teat tramps and mastitis, contribute to the high cost of lameness.

Lameness has been estimated to cost about $ 650 per cow although the highest cost of lameness is from premature culling and loss of the entire value of the animal. Hairy foot warts are the cause of lameness in 60-65% of lame cows and 15-20% of all cows in a typical herd are lame at any one time. During a period of lameness, milk production decreases by as much as 25%. The ability to control the lameness problem can have a large financial impact on a dairy's operations.

The dairy industry has used several of the following topical applications in an attempt to treat lameness:
1) Antibiotics such as tetracycline, oxytetracycline and lincomycin.
2) Copper sulfate has been widely used for several years but it is not an effective treatment method for hairy foot warts. There is also environmental concern due to Copper build-up from large dairy operation run-off. Usage has therefore been discouraged.
3) Zinc sulfate is used on a limited basis. A 1990 study reported that zinc sulfate footbaths were effective at controlling the spread of hairy foot warts and treating mild lesions but ineffective against more serious lesions. The study also recommended avoiding the mixing of solutions containing Copper and Zinc with antibiotics due to the fact that tetracycline can be inactivated by these solutions.
4) Formalin is a 38% formaldehyde mixture. Several studies report that a 5% formalin treatment is effective in controlling hairy foot wart outbreaks. However, formalin loses its effectiveness quickly when exposed to air. It also has difficulty penetrating organic matter so hooves must be cleaned prior to treatment if the hooves are muddy or packed with manure. In spite of all that, the biggest drawback is formalin's toxicity. It is carcinogenic and poses a health hazard to employees as well the animal's meat and milk.
5) Acidified Sodium Chlorite, a broad spectrum antimicrobial, has recently been approved for use in disinfecting beef and poultry carcasses. For use in live animals, it is easily inactivated by organic matter so footbaths must remain clean. Because of its low pH (pH 2.3-3.2), it is corrosive to metal and equipment and is especially toxic to cows.
6) Iodine is normally used in teat dips but other iodine products have been used by dairy farms in an attempt to control hairy foot warts. Claims as to its effectiveness as a footbath application are only anecdotal. Iodine is easily inactivated by organic matter and it needs a long contact period with the animal to be effective. Iodine products without an emollient can be highly irritating to an animal's skin.
7) Peroxides disrupt the cellular mechanisms of anaerobic bacteria but, in high concentrations, peroxides are very damaging to all cells. Products such as hydrogen peroxides are not stable and quickly lose their effectiveness when exposed to air or organic matter. However, stabilized peroxide compounds are available and have a longer lasting antimicrobial effect.

Because of the problems associated with existing footbath and topical treatments, researchers have tested the use of systemic antibiotics to treat hairy foot warts, but with mixed results. In tests on cattle that were injected with penicillin twice a day for three days, lesions healed within 21 days. But, these injectable antibiotics had a negative impact on the volume and quality of meat and milk production. Specific vaccines have been developed against the bacteria that cause hairy foot warts but there has been a high rate of reoccurrence. Therefore, they can only be used to “control” rather than to “cure” the problem.

Non-antibiotic footbaths can be effective in reducing bacteria that cause hairy foot wart but in order to be effective they must achieve four factors:
They must kill the bacteria.
They must be exposed to the bacteria long enough to be effective.
The correct concentration must be used to get an effective kill.
The product must remain active in the environment in which it is used.

Application methods for the treatment of lameness in dairy cows are as follows:
a. dips,
b. sprays,
c. foams,
d. wraps (where the wound is initially cleaned and then wrapped)

### SUMMARY OF THE INVENTION

The disclosed compositions and methods provide a method for preventing and controlling hairy warts and foot rot in hoofed animals. The compositions and methods are suitable for use with any domesticated animal including, but not limited to, cows, goats, sheep, equine and the like. The disclosed compositions comprise a biocidal system comprising a primary biocide, a secondary biocide and a pH buffer; and a surfactant, all in an aqueous composition.

Accordingly, a primary object of the invention is providing compositions effective in killing one or more pathogens. Non-limiting examples include Pseudomonas aeruginosa, Staphylococcus aureus, Staphylococcus epidermidis, Streptococcus agalactiae, Brucella melitensis, Corynebacterium bovis, Escherichia coli, (E. coli) and Klebsiella pneumoniae. In addition, the disclosed compositions are suitable for controlling yeast.

A further object of the invention is providing compositions effective in preventing the infection and/or spread of one or more pathogens from an infected domesticated animal to other domesticated animals or an apparatus that contacts any infected domesticated animal. Non-limiting examples include holding areas before milking, milking parlors, milking tables, feed-stall areas, improperly used footbath units, “alley ways”, bedding and stalls. Non-limiting examples of infection causing pathogens include Streptococcus agalactiae and Staphylococcus aureous.

A further object of the invention is providing compositions effective against environmental pathogens. Non-limiting examples include Streptococcus spp, Escherichia coli, Klebsiella species, A. pyogenes and Pseudomonas species.

A further object of the invention is providing compositions and methods for preventing foot rot and methods for treating environmental pathogens. Non-limiting examples include Fusobacterium necrophorum, Dichelobacter (formally Bacteroides), nodosus and Bacteroides melaminogenicus.

A yet further object of the invention is providing compositions and methods for preventing hairy foot warts and methods for treating environmental pathogens. Non-limiting examples include spirochete of the genus Treponemais (T. spirochetes)

A yet further object of the invention is providing compositions that are a replacement for copper sulfate based treatments.

Another object of the invention is providing compositions that are a replacement for acidified copper sulfate based treatments.

Another object of the invention is providing compositions and methods for preventing lameness caused by hairy foot warts in a domesticated animal.

Another object of the invention is providing compositions and methods for preventing lameness caused by foot rot in a domesticated animal.

Additional advantages will be set forth in part in the description that follows and in part will be obvious from the description or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### SUMMARY OF THE FIGURES

FIG. 1, is a photograph depicting hairy foot warts.

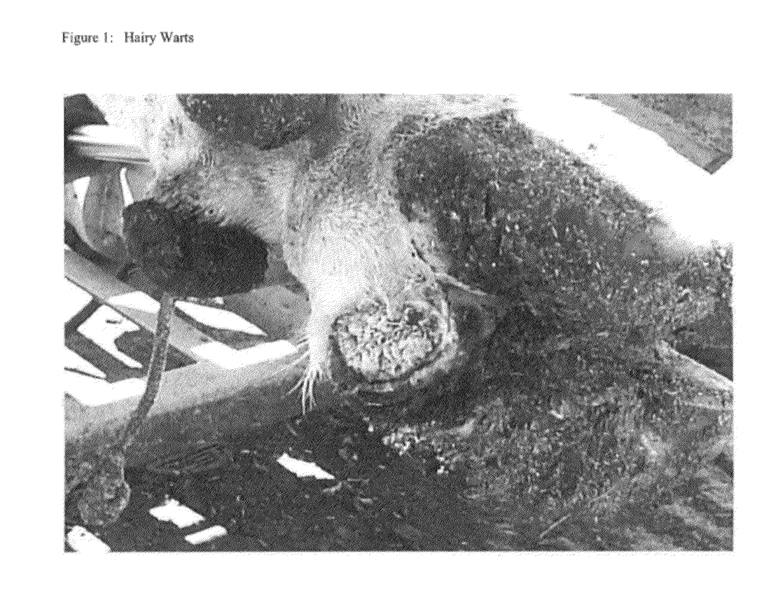

FIG. 2, is a photograph depicting foot rot.

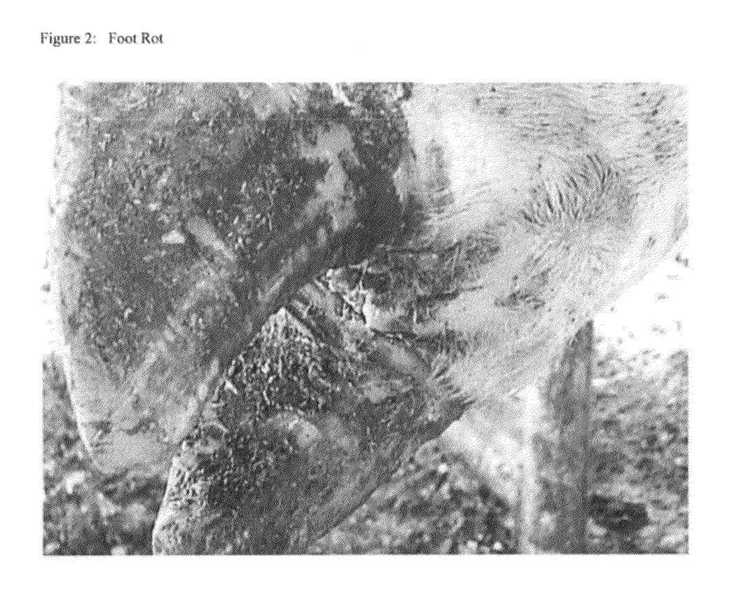

FIG. 3, is a photograph depicting a footbath system.

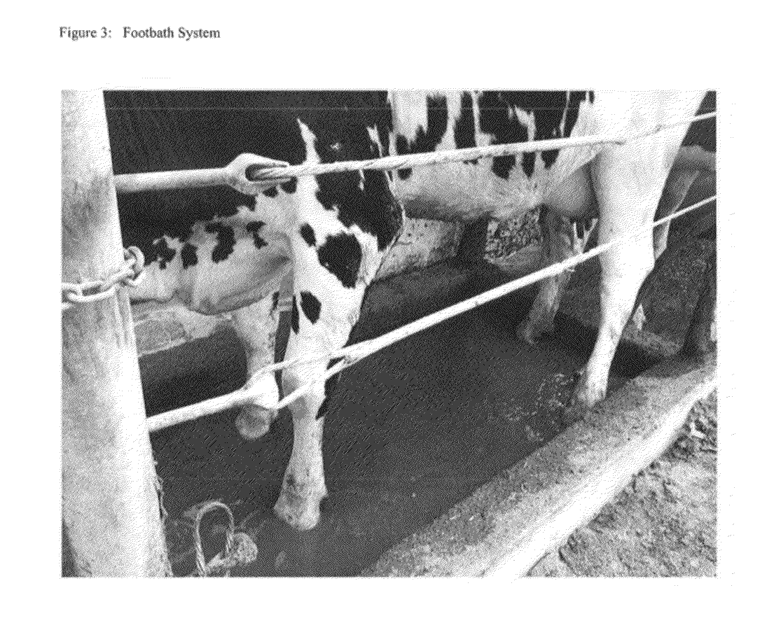

FIG. 4, is a photograph depicting a healthy hoof.

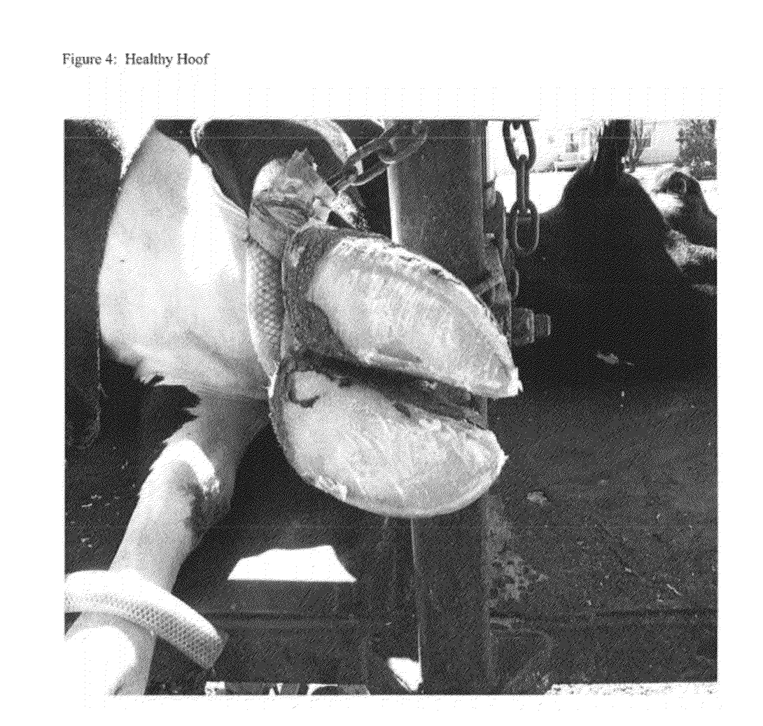

FIG. 5, is a photograph depicting an examination table system.

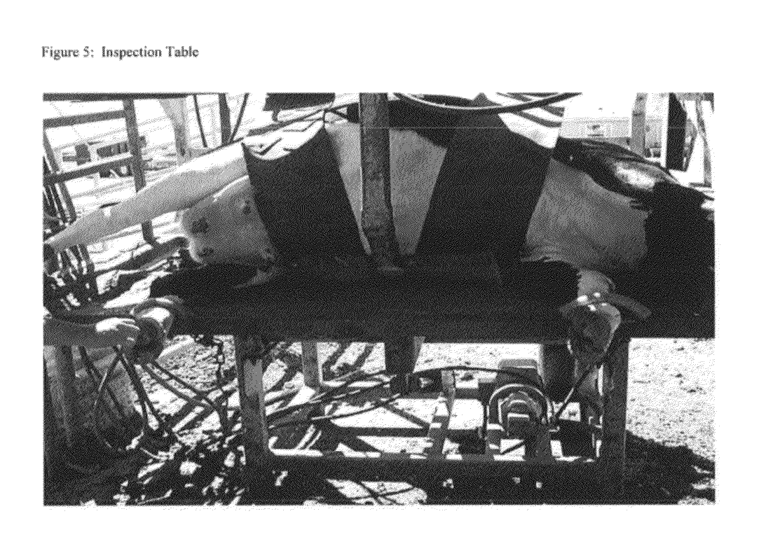

### DESCRIPTION OF THE PREFERRED EMBODIMENT

### Treatment Compositions

The inventive composition generally includes a biocide system, which includes a primary biocide and a pH buffering component. The primary biocide is selected according to the nature of the microorganisms sought to be controlled, for example, a quaternary ammonium salt. The pH buffer is an electrically-activated acid/salt or base/salt composition that aids in breaking down the cell walls of microorganisms for the delivery of the primary biocide without causing irritation to the skin of the livestock. By way of example, a suitable pH buffer is disclosed in U.S. Pat. No. 7,824,524, which is incorporated by reference herein in its entirety, or in a U.S. patent application Ser. No. 13/346,160, entitled “Reactive, non-corrosive, and dermal-friendly composition and methods for manufacturing” which is also incorporated by reference herein in its entirety and filed contemporaneously with this patent application. The pH buffer is chosen for compatibility with the primary biocide.

Along with the primary biocide, the inventive composition includes a surfactant which helps disperse the biocidal system disperse on the treated surfaces of the pen along with a thickening agent, which helps keep the biocidal system in contact with the treated surfaces of the pen. Further, the inventive composition includes a carrier which helps dissolve the other components and aids in the delivery of the biocidal system. Additionally, the inventive composition may include other substances which do not contribute to its antimicrobial function but add to the usability of the product; for example, the composition may include dyes and fragrances.

### Biocidal System

The disclosed compositions comprise from about 0.05% to about 12.0% by weight of a biocidal system. The biocidal system comprises at least about 5% by weight of a primary biocide, at least about 5% by weight of a secondary biocide, and at least about 45% by weight of an pH buffer agent.

### Primary Biocide

Suitable biocides include quaternary ammonium compounds chosen from (C12-C14 alkyl)(C1-C2 dialkyl)benzyl ammonium salts, N—(C12-C18 alkyl)heteroaryl ammonium salts, and N—[(C12-C14 alkyl)(C1-C2 dialkyl)]heteroarylalkylene ammonium salts. Non-limiting examples of the (C12-C14 alkyl)(C1-C2 dialkyl)benzyl ammonium salts include (C12-C14 alkyl)dimethyl-benzyl ammonium chloride, (C12-C14 alkyl)dimethylbenzyl ammonium bromide, and (C12-C14 alkyl)dimethylbenzyl ammonium hydrogen sulfate. Non-limiting examples of the N—(C12-C18 alkyl)heteroaryl ammonium salts include cetyl pyridinium chloride, cetyl pyridinium bromide, and cetyl pyridinium hydrogen sulfide. For the N—(C12-C18 alkyl)heteroaryl ammonium salts other anions can be used.

Further examples of quaternary ammonium compounds suitable for use as the primary biocides include cetyltrimethylammonium chloride, stearyltrimethylammonium chloride, isostearyltrimethylammonium chloride, lauryltrimethylammonium chloride, behenyltrimethyl-ammonium chloride, octadecyltrimethylammonium chloride, cocoyltrimethylammonium chloride, cetyltrimethylammonium bromide, stearyltrimethylammonium bromide, lauryl-trimethylammonium bromide, isostearyllauryldimethylammonium chloride, dicetyldimethyl-ammonium chloride, distearyldimethylammonium chloride, dicocoyldimethylammonium chloride, gluconamidopropyldimethylhydroxyethylammonium chloride, di[polyoxyethylene(2)]oleylmethylammonium chloride, dodecyldimethylethylammonium chloride, octyldihydroxyethylmethylammonium chloride, tri[polyoxyethylene(5)]-stearylammonium chloride, polyoxypropylenemethyldiethylammonium chloride, lauryl-dimethyl(ethylbenzyl)ammonium chloride, behenamidopropyl-N,N-dimethyl-N-(2,3-dihydroxypropyl)ammonium chloride, tallowedimethylammoniopropyltrimethylammonium dichloride, and benzalconium chloride.

A second group of suitable biocides includes copper, zinc, silver, salts of chlorides, chlorites, perchlorates, hypochlorates, hypochlorites, sulfates, sulfites, bisulfates and bisulfites. Also, colloid metal such as silver, gold, copper and zinc have superior biocidal properties. Colloidal, silver, gold, copper and zinc are extracted and created as ultrafine (0.010-0.001 micron) particles.

A third group of suitable biocides include organic acids which are safe under the FDA GRAS guidelines for food production yet still effective in controlling bacteria. The basic principle action of organic acids on bacteria is that non-dissociated organic acids can penetrate a bacterium cell wall and cause disruption due to the fact it cannot tolerate a wide internal and external pH gradient. With the passive diffusion of organic acids into the bacteria, the acids will dissociate and lower the bacteria's internal pH, leading to an environment that will inhibit or stop the growth of bacteria and viruses. The anionic part of the organic acids that cannot escape the bacteria in its dissociated form will accumulate within the bacteria and disrupt many metabolic functions. This will cause the osmotic pressure inside the cell to increase which state is incompatible with bacterial survival.

The first group of suitable organic acids is Lactic, Acetic, Formic, Fumaric, Citric, Oxalic, Adipic and Uric.

The second group of suitable organic acids is the carboxylic acids, whose acidity is associated with their carboxyl group —COOH. Sulfonic acids, containing the group —SO2OH, are relatively stronger acids. The relative stability of the conjugate base of the acid determines its acidity. In some biological systems more complex organic acids such as L-lactic, citric, and D-glucuronic acids are formed. These use the hydroxyl or carboxyl group.

The third group of suitable organic acids are Humic, Sebacic, Stearic, Gallic, Palmitic, Caffeic, Glyoxylic, Fulvic, Carnosic, Anthranilic, Ellagic, Lipoic, Chlorogenic, Rosmarinic, Phosphoric, Methacrylic, Oleanic, Nitrohumic, Florocinnamic, Hexaflorosilicic, Hydrofluoric, Hydroxycitric and Silicofluoric.

The fourth group of suitable organic acids is fruit acids. The acids in fruits are chiefly acetic, malic, citric, tartaric, oxalic, and in some instances boric. Malic acid is present in apples, pears, currants, blackberries, raspberries, quince, pineapple, cherries, and rhubarb. Citric acid is found in lemons, oranges, grapefruit, lemons, limes, quince, gooseberry, strawberry, raspberry, currant, and cranberry. Tartaric acid occurs in grapes. Boric acid is found in many fresh fruits and vegetables. Mandelic acid is present in almonds.

The fifth group of suitable organic acids is beta hydroxy acids which is a type of phenolic acid. Salicylic acid is a colorless crystalline organic acid whose main active ingredient obtained from this source is a monohydroxiybenzoic acid.

The sixth group of suitable organic acids is a class of products that break biofilm. Biofilms are the protective layer/barrier that surround bacteria. Some species are not able to attach to a surface on their own but are often able to anchor themselves to the matrix or the bacteria cells. It is during this colonization that the cells are able to communicate via its quorum sensing ability. Once colonization has begun, the biofilm grows through a combination of cell division and recruitment. The final stage of biofilm formation is known as development and is the stage in which the biofilm is established and may only change in shape and size. The development of a biofilm may allow an aggregate cell colony to be increasingly resistant. A biofilm's hard protective surface can be broken by Lactobacillus sc Nisin which is produced by fermentation using the bacterium Lactococcus lactis. This is obtained from the culturing of Lactococcus lactis on natural substrates, such as milk or dextrose, and is not chemically synthesized. This is a peptide which is produced by the food grade dairy starter bacterium Lactococcus lactis.

A seventh group of suitable organic acids is natural enzymes. Enzymes are proteins that catalyze chemical reactions and range from just 62 amino acid residues. Typically, these are protease, lipase, diastase and cellulase enzymes. Enzymes are usually very specific as to which reactions they catalyze and the substrates that are involved in these reactions. The shape, charge and hydrophilic/hydrophobic nature characterize the enzymes.

### Secondary Biocide

Secondary biocides include copper, zinc, silver, salts of chlorides, chlorites, perchlorates, hypochlorites, sulfates, sulfites, bisulfates and bisulfites. Also colloid metal such as silver, gold, copper and zinc have superior biocidal properties. Colloidal silver, gold, copper and zinc are extracted and created as ultrafine (0.010-0.001 micron) particles. The beneficial natural elements of precious gold and silver, and primal elemental copper and zinc, can cure of illnesses, alleviation of pain. Other cures using colloidal metals as topical include their use in treating burns, and skin infections, other glandular problems, stress related pains and symptoms, also to clean the blood and circulatory system, boost collagen production and speed up synapse response of the brain.

### pH Buffer

A biocidal, dermal, non-corrosive acid composition, having a maximum proton count of 1.5×10̂25, an embodied conductivity range of from 250 mV to 1500 mV and a 0.1% solution of the composition having a pH of under 2.0. By way of example, such a composition disclosed in U.S. Pat. No. 7,824,524, which is incorporated by reference herein in its entirety, or in a U.S. patent application Ser. No. 13/346,160, entitled “Reactive, non-corrosive, and dermal-friendly composition and methods for manufacturing” and filed contemporaneously with this patent application. and should be understood to be applicable to the present invention. In addition, other biocidal, dermal, non-corrosive acid compositions could be used providing they have a maximum proton count of 1.5×1025, an embodied conductivity range of from 250 mV to 1500 mV and a 0.1% solution of the composition having a pH of under 2.0.

### Surfactant

A surfactant component includes ingredients that modify the water in the system making it suitable from use with several types of water such as hard water, soft water, sulfite contaminated water, rain water, pond water, well water or calcium rich water. This allows the embodiment composition to cling or stick to the domesticated animal's hair and skin. Cationic surfactants of the quaternary ammonium compound referred to as “poly quats” are used in many hair shampoos and conditioners. These agents improve the body of the hair and reduce its static charge. Surfactant products often used for human hair treatment provide the cling or stickiness necessary for the application of the biocidal compositions to animals. Quaternary ammonium compounds which are more compatible with anionic surfactants generally have an inadequate conditioning effect.

In-order to improve the ability for an aqueous mixture to adhere to an animal's hair, dialkyl diallyl ammonium chloride/acrylic acid-type polymers is added. This method for improving the stickiness properties of the composition encompasses adding an effective amount of a polymer comprising:

I. about 60 to about 99%, based on total polymer weight, of a quaternary diallyl dialkyl ammonium monomer, wherein alkyl groups are independently selected from alkyl groups of 1 to 18 carbon atoms, preferably C 1-4 alkyl, and wherein said quaternary diallyl dialkyl ammonium monomer's counterion is selected from the group consisting of conjugate bases of acids having an ionization constant greater than 10-13, more preferably selected from the group consisting of fluoride, chloride, bromide, hydroxide, nitrate, acetate, hydrogen sulfate, and primary phosphates; and

II. about 1 to about 40%, based on total polymer weight, of an anionic monomer selected from the group consisting of acrylic acid and methacrylic acid; wherein the average molecular weight of said polymer ranges from about 50,000 to about 10,000,000, as determined by gel permeation chromatography.

The polymer base can also be a combination of one or more bases, for example, glycerol in combination with ethoxylated partial glyceride fatty acid esters. These include branched chain esters, ethoxylated partial glyceride fatty acid esters, protein derivatives, lanolin and lanolin derivatives, and fatty alcohol ethoxylates, emollient oils, fatty acids, fatty alcohols and their esters. Other examples of suitable bases include glycerine, sortibal aloe, poylglycols, polyethylene glycol, polyoxyethylene and polyethylene oxide.

### Adjunct Ingredients

The disclosed compositions can further comprise one or more dyes at levels of from about 0.001% to 0.5%. Non-limiting examples of suitable dyes are Alizarine Light Blue B (C.I. 63010), Carta Blue VP (C.I. 24401), Acid Green 2G (C.I. 42085), Astrogen Green D (C.I. 42040), Supranol Cyanine 7B (C.I. 42675, Maxilon Blue 3RL (C.I. Basic Blue 80), Drimarine Blue Z-RL (C.I. Reactive Blue 18), Alizarine Light Blue H-RL (C.I. Acid Blue 182), FDand C Blue No. 1 and FDand C Green No. 3. (See U.S. Pat. No. 4,248,827 and U.S. Pat. No. 4,200,606, both incorporated herein by reference.) C.I. refers to Color Index.

Other colors which can be Lakes that may be used are FD and C Blue No. 1—Brilliant Blue FCF, (blue shade), FD and C Blue No. 2—Indigotine, (dark blue shade), FD and C Green No. 3—Fast Green FCF, (turquoise shade), FD and C Red No. 40—Allura Red AC, (red shade), FD and C Red No. 3—Erythrosine, (pink shade, commonly used in glace cherries), FD. and C Yellow No. 5—Tartrazine, (yellow shade), FD and C Yellow No. 6—Sunset Yellow FCF, E110 (orange shade).

### Carriers

The balance of the disclosed compositions comprises a carrier. The carrier can be any suitable material that can dissolve the active ingredients and co-ingredients and deliver the biocidal system to the infected areas of the domesticated animal being treated. Water is a convenient carrier for liquid embodiments of the disclosed composition. Other embodiments of the disclosed compositions include gels, dips and sprays. Foams and creams can be used for treating cases where the infection is chronic and the infected animals must be isolated from the rest of the herd in order to provide more intense treatment.

### Example Formulations

The selection and proportions of specific components for the inventive biocidal system will be based on the particular microorganisms to be controlled and the method of delivery, and other factors known to a person of skill in the art and/or easily derived from routine engineering using this disclosure as a guideline. By way of example, Tables 1 and 2 show the selection and proportions of specific components suitable for a biocidal system for use as treatments for hairy foot wart and/or foot rot. These compositions are provided as non-limiting examples of effective compositions. The amount of each component is measured in grams.

TABLE 1

| Ingredients | 1 | 2 | 3 | 4 | 5 |
|---|---|---|---|---|---|
| cetyl pyridinium chloride | 0.10 | 0.25 | 0.35 | 0.50 | 0.25 |
| zinc chloride | 1.0 | 1.0 | 1.0 | 1.0 | 3.0 |
| pH buffer | 6.0 | 6.0 | 6.0 | 6.0 | 6.0 |
| PEG 6 | 1.0 | 1.0 | 1.0 | 1.0 | 1.0 |
| xanthan gum | 0.0 | 0.0 | 0.0 | 0.0 | 1.0 |
| color | trace | trace | trace | trace | trace |
| carrier | balance | balance | balance | balance | balance |

TABLE 2

| Ingredients | 1 | 2 | 3 | 4 | 5 |
|---|---|---|---|---|---|
| cetyl pyridinium chloride | 0.25 | 0.25 | 0.25 | 0.25 | 0.25 |
| copper chloride | 1.0 | 3.0 | 3.0 | 3.0 | 3.0 |
| pH buffer | 6.0 | 6.0 | 7.0 | 7.0 | 6.0 |
| PEG 6 | 1.0 | 1.0 | 1.0 | 1.0 | 1.0 |
| xanthan gum | 0.0 | 0.0 | 0.0 | 1.0 | 1.0 |
| color | trace | trace | trace | trace | trace |
| carrier | balance | balance | balance | balance | balance |

### Methods of Use

The disclosed compositions can be used for various applications with the application methods and dosage regimens dictated by the frequency of milking. The reason it is based on the frequency of the milking is the footbath units are generally accessible to the domesticated animals as they make their way from the milking parlor back to their stalls, corrals, barns or pasture.

1) Footbath applications usually consist of a tank filled with at least about 4 to 6 inches of composition or enough to cover any Abscess, Sole bruise, Interdigital skin, Interdigital cleft, or any area where there is Foot rot, Hairy foot warts or Laminitis on the hoof. The biocidal composition must be deep enough so as to make contact with any infected area of the hoof.

2) Foam applications are effective where the foam composition can be applied directly to the hoof in order to insure the hoof is thoroughly coated with the foam.

3) Gel applications can be utilized in a footbath system as a replacement for the liquid “dip” composition. The main advantage of the gel is its thickness which will allow the embodied composition a longer contact period with the hoof.

4) A wrap application can be used to apply the embodied composition in manner a that will allow the infected hoof to be kept free of water, whereby allowing the biocidal composition the longest contact period with the infected hoof.

### Examples

The term “effective amount” as used herein means “an amount of a composition as disclosed herein, effective at dosages and for periods of time necessary to achieve the desired or therapeutic result.” An effective amount may vary according to factors known in the art, such as the disease state, age, sex, species, and weight of the domesticated animal being treated. Although particular dosage regimes may be described in examples herein, a person skilled in the art would appreciated that the dosage regime may be altered to provide optimum therapeutic response. For example, several divided doses may be administered daily or the dose may be proportionally reduced as indicated by the exigencies of the therapeutic situation. In addition, the compositions of the present disclosure can be administered as frequently as necessary to achieve a therapeutic amount.

The following procedures can be used to evaluate the disclosed compositions against various microorganisms. Bacterial testing was completed at BSK Food Laboratory located in Fresno Calif. using E. coli ATCC #25922 strain. The exposure time was 60 seconds and the results are listed in Table A. The reduction in bacterial growth was 99.999%.

TABLE A

| Sample | Control units | Results units |
|---|---|---|
| Biocide 0.15% | 999,000 cfu/ml | <1 cfu/ml |
| Biocide 0.30% | 999,000 cfu/ml | <1 cfu/ml |
| Biocide 0.5% | 999,000 cfu/ml | <1 cfu/ml |

*cfu—colony forming units

Bacterial testing was done using Staphylococcus aureus ATCC #6538. The results are listed in Table B. The reduction in bacterial growth was a 99.9999%.

TABLE B

| Species | Control units | Results units |
|---|---|---|
| Staphylococcus aureus | 7.9 × 10\hat{ }7 cfu/ml | 2.5 cfu/ml |

Bacterial testing was completed at Biological Consulting Services of North Florida, Inc on E. coli (ATCC 15597), Salmonella enterica (ATCC BAA-711), and Methicillin Resistant Staphylococcus aureus (MRSA; BAA-44). The results are listed in Table C.

TABLE C

| Sample | Control units (cfu/ml) | Results units (cfu/ml) |
|---|---|---|
| E. coli | 9.3 × 10\hat{ }5 | <0.5 |
| S. enterica | 1.1 × 10\hat{ }6 | <0.5 |
| MRSA | 1.0 × 10\hat{ }6 | <0.5 |

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A composition for improving lameness in domesticated animals comprising:
a) from about 0.05% to about 12.0% by weight of a biocidal system comprising:
i) at least 5% by weight of a primary biocide; and
ii) at least 5% by weight of a secondary biocide; and
iii) at least 45% by weight of a pH buffer agent.

2. The composition of claim 1 further comprising from about 0.01% to 2% by weight of a surfactant;

3. The composition of claim 1 further comprising from about 0.1% to about 4% by weight of a thickening agent.

4. The composition of claim 1 further comprising an aqueous based carrier.

5. The composition according to claim 1, wherein the primary biocide is a quaternary ammonium salt comprising at least one aryl or heteroaryl unit.

6. The composition according to claim 1, wherein the primary biocide is chosen from (C12-C14 alkyl)(C1-C2 dialkyl)benzyl ammonium salts, N—(C12-C18 alkyl)heteroaryl ammonium salts, and N—[(C12-C14 alkyl)(C1-C2 dialkyl)]heteroarylalkylene ammonium salts.

7. The composition according to claim 1, wherein the primary biocide is chosen from (C12-C14 alkyl)dimethylbenzyl ammonium chloride, (C12-C14 alkyl)dimethylbenzyl ammonium bromide, (C12-C14 alkyl)dimethylbenzyl ammonium hydrogen sulfate, cetyl pyridinium bromide, and cetyl pyridinium hydrogen sulfide.

8. The composition according to claim 1, wherein the primary biocide is cetyl pyridinium chloride.

9. The composition according to claim 1, wherein the secondary biocide is chosen from copper, zinc, silver, salts of chlorides, chlorites, perchlorates, hypochlorites, sulfates and sulfites.

10. The composition according to claim 1, wherein the secondary biocide component is zinc chloride.

11. The composition according to claim 1, wherein the primary biocide is chosen from several fruit acids such as acetic, malic, citric, tartaric, oxalic, tartaric, mandelic and boric.

12. The composition according to claim 1, wherein the primary biocide is chosen from several organic acids such as Lactic, Acetic, Formic, Fumaric, Adipic, Citric, Oxalic, or Uric.

13. The composition according to claim 1, wherein the primary biocide is chosen from several organic acids containing carboxylic and/or Sulfonic acids such as Humic, Sebacic, Stearic, Gallic, Palmitic, Caffeic, Glyoxylic, Fulvic, Carnosic, Anthranilic, Ellagic, Oleanic, Lipoic, Chlorogenic, Rosmarinic, Phosphoric, Methacrylic, Nitrohumic, Florocinnamic, Hexaflorosilicic, Hydrofluoric, Hydroxycitric and Silicofluoric.

14. The composition according to claim 1, wherein the primary biocide is chosen from suitable organic acids that are beta hydroxy acids such Salicylic acid.

15. The composition according to claim 1, wherein the primary biocide is chosen from several natural and/or organic acids that break the biofilm. Such acids may be chosen from fermented Lactococcus lactis, Lactococcus cremoris, Lactococcus hordniae, Lactococcus garvieae, Lactococcus platarum, Lactococcus raffinolactis, or Lactococcus piscium products.

16. The composition according to claim 1, wherein the primary biocide is chosen from a wide range of natural enzymes such as proteolytic, amylolytic, cellulase, papin, invertase, lipolytic, pepsin, bromelain and lactase.

17. The composition according to claim 1, wherein the biocidal system comprises:
i) from about 5% to about 15% by weight of a primary biocide; and
ii) from about 15% to about 25% by weight of a secondary biocide; and
iii) at least about 70% by weight of an pH buffer agent.

18. The composition according to claim 1, wherein the biocidal system comprises:
i) from about 5% to about 15% by weight of a primary biocide of cetyl pyridinium chloride; and
ii) from about 15% to about 25% by weight of a secondary biocide of zinc chloride.

19. The composition according to claim 1, wherein the biocidal system comprises:
i) from about 5% by weight of a primary biocide; and
ii) from about 25% to about 50% by weight of a secondary biocide; and
iii) at least about 45% by weight of an pH buffer agent.

20. The composition according to claim 1, wherein the biocidal system comprises:
i) from about 5% by weight of a primary biocide of cetyl pyridinium chloride; and
ii) from about 25% to about 50% by weight of a secondary biocide of zinc chloride.

21. The composition according to claim 1, wherein the biocidal system comprises:
i) from about 5% by weight of a primary biocide; and
ii) from about 5% by weight of a secondary biocide; and
iii) at least about 90% by weight of an pH buffer agent.

22. The composition according to claim 1, wherein the biocidal system comprises:
i) from about 5% by weight of a primary biocide of cetyl pyridinium chloride; and
ii) from about 25% to about 50% by weight of a secondary biocide of zinc chloride.

23. The composition according to claim 1, where the pH buffer is a biocidal, dermal, non-corrosive acid composition, having a maximum proton count of 1.5×10̂25, an embodied conductivity range of from 250 mV to 1500 mV and a 0.1% solution of the composition having a pH of under 2.0.

24. The composition according to claim 2, where the surfactant is chosen from about 60% to about 99%, based on total polymer weight, of a quaternary diallyl dialkyl ammonium monomer, wherein alkyl groups are independently selected from alkyl groups of 1 to 18 carbon atoms, C 1-4 alkyl, and wherein said quaternary diallyl dialkyl ammonium monomer's counterion is selected from the group consisting of conjugate bases of acids having an ionization constant greater than 10-13, selected from the group consisting of fluoride, chloride, bromide, hydroxide, nitrate, acetate, hydrogen sulfate and primary phosphates.

25. The composition according to claim 2, where the surfactant is chosen from about 1% to about 40%, based on total polymer weight, of an anionic monomer selected from the group consisting of acrylic acid and methacrylic acid, wherein the average molecular weight of said polymer ranges from about 50,000 to about 10,000,000, as determined by gel permeation chromatography.

26. The composition according to claim 2, where the surfactant is chosen from a combination of one or more polymer bases.

27. The composition according to claim 3, wherein the thickening agent is chosen from hydroxynethyl cellulose, hydroxyethyl cellulose, methylcellulose, hydroxypropyl cellulose, methyl cellulose, carboxy methylcellulose, emulsifying waxes, alkyl triammonium methosulfate, and ceteraryl octanoate.

28. The composition according to claim 3, wherein the thickening agent is hydroxyethyl cellulose.

29. The composition according to claim 3, wherein the thickening agent is chosen from polysaccharides and linear sulfated polysaccharides.

30. The composition according to claim 3, wherein the thickening agent is polysaccharides and linear sulfated polysaccharides of natural origin.

31. The composition according to claim 3, wherein the thickening agent is chosen from polysaccharides or linear sulfated polysaccharides such as xanthan gum.

32. The composition according to claim 3, wherein the thickening agent is a poylsaccharides starch which can be unmodified or modified using acid, enzymes, alkaline, bleached, oxidized, acetylated, hydroxpropylated, octenylsuccinic anhydride, carboxyethylated, phosphate, hydroxypropyl, acetylated oxidated, cationic, cold water, pregelatinized and instant starch.

33. A composition for improving lameness in a domesticated animal comprising:
a) from about 0.05% to about 12% by weight of a biocidal system comprising:
i) at least about 5% to 15% by weight of a cetyl pyridinium chloride; and
ii) at least about 5% to about 15% by weight of a zinc chloride biocide; and
iii) at least about 70% by weight of a pH buffer agent; and
b) at least about 0.01% to about 2% by weight of a polyethylene glycol base; and
c) from about 0.1% to about 4% by weight of a xanthan gum; and
d) the balance being an aqueous based carrier.

34. A composition for improving lameness in a domesticated animal comprising:
a) from about 0.05% to about 12% by weight of a biocidal system comprising:
i) at least about 5% to 15% by weight of a cetyl pyridinium chloride; and
ii) at least about 5% to about 15% by weight of a copper chloride biocide; and
iii) at least about 70% by weight of a pH buffer agent; and
b) from about 0.01% to about 2% by at least of a polyethylene glycol base; and
c) from about 0.1% to about 4% by weight of a xanthan gum; and
d) the balance being an aqueous based carrier.

35. A composition for improving lameness in a domesticated animal comprising:
a) from about 0.05% to about 12% by weight of a biocidal system comprising:
i) at least about 5% to 15% by weight of a cetyl pyridinium chloride; and
ii) at least about 5% to about 15% by weight of a zinc sulfate biocide; and
iii) at least about 70% by weight of a pH buffer agent; and
b) at least about 0.01% to about 2% by weight of a polyethylene glycol base; and
c) from about 0.1% to about 4% by weight of a xanthan gum; and
d) the balance being an aqueous based carrier.

36. A composition for improving lameness in a domesticated animal comprising:
a) from about 0.05% to about 12% by weight of a biocidal system comprising:
i) at least about 5% to 15% by weight of a cetyl pyridinium chloride; and
ii) at least about 5% to about 15% by weight of a copper sulfate biocide; and
iii) at least about 70% by weight of a pH buffer agent; and
b) from about 0.01% to about 2% by weight of a polyethylene glycol base; and
c) from about 0.1% to about 4% by weight of a xanthan gum; and
d) the balance being an aqueous based carrier.

37. A composition for improving lameness in a domesticated animal comprising:
a) from about 0.05% to about 12% by weight of a biocidal system comprising:
i) at least about 5% to 15% by weight of a cetyl pyridinium chloride; and
ii) at least about 15% to about 25% by weight of a zinc chloride biocide; and
iii) at least about 60% by weight of a pH buffer agent; and
b) at least about 0.01% to about 2% by weight of a polyethylene glycol base; and
c) from about 0.1% to about 4% by weight of a xanthan gum; and
d) the balance being an aqueous based carrier.

38. A composition for improving lameness in a domesticated animal comprising:
a) from about 0.05% to about 12% by weight of a biocidal system comprising:
i) at least about 5% to 15% by weight of a cetyl pyridinium chloride; and
ii) at least about 15% to about 25% by weight of a copper chloride biocide; and
iii) at least about 60% by weight of a pH buffer agent; and
b) at least about 0.01% to about 2% by weight of a polyethylene glycol base; and
c) from about 0.1% to about 4% by weight of a xanthan gum; and
d) the balance being an aqueous based carrier.

39. A composition for improving lameness in a domesticated animal comprising:
a) from about 0.05% to about 12% by weight of a biocidal system comprising:
i) at least about 5% to 15% by weight of a cetyl pyridinium chloride; and
ii) at least about 15% to about 25% by weight of a zinc sulfate biocide; and
iii) at least about 60% by weight of a pH buffer agent; and
b) at least about 0.01% to about 2% by weight of a polyethylene glycol base; and
c) from about 0.1% to about 4% by weight of a xanthan gum; and
d) the balance being an aqueous based carrier.

40. A composition for improving lameness in a domesticated animal comprising:
a) from about 0.05% to about 12% by weight of a biocidal system comprising:
i) at least about 5% to 15% by weight of a cetyl pyridinium chloride; and
ii) at least about 15% to about 25% by weight of a copper sulfate biocide; and
iii) at least about 60% by weight of a pH buffer agent; and
b) at least about 0.01% to about 2% by weight of a polyethylene glycol base; and
c) from about 0.1% to about 4% by weight of a xanthan gum; and
d) the balance being an aqueous based carrier.

41. A composition for improving lameness in a domesticated animal comprising:
a) from about 0.05% to about 12% by weight of a biocidal system comprising:
i) at least about 5% by weight of a cetyl pyridinium chloride; and
ii) at least about 25% to about 50% by weight of a zinc chloride biocide; and
iii) at least about 45% by weight of a pH buffer agent; and
b) at least about 0.1% to about 2% by weight of a polyethylene glycol base; and
c) from about 0.1% to about 4% by weight of a xanthan gum; and
d) the balance being an aqueous based carrier.

42. A composition for improving lameness in a domesticated animal comprising:
a) from about 0.05% to about 12% by weight of a biocidal system comprising:
i) at least about 5% by weight of a cetyl pyridinium chloride; and
ii) at least about 25% to about 50% by weight of a copper chloride biocide; and
iii) at least about 45% by weight of a pH buffer agent; and
b) at least about 0.1% to about 2% by weight of a polyethylene glycol base; and
c) from about 0.1% to about 4% by weight of a xanthan gum; and
d) the balance being an aqueous based carrier.

43. A composition for improving lameness in a domesticated animal comprising:
a) from about 0.05% to about 12% by weight of a biocidal system comprising:
i) at least about 5% by weight of a cetyl pyridinium chloride; and
ii) at least about 25% to about 50% by weight of a zinc sulfate biocide; and
iii) at least about 45% by weight of a pH buffer agent; and
b) at least about 0.1% to about 2% by weight of a polyethylene glycol base; and
c) from about 0.1% to about 4% by weight of a xanthan gum; and
d) the balance being an aqueous based carrier.

44. A composition for improving lameness in a domesticated animal comprising:
a) from about 0.05% to about 12% by weight of a biocidal system comprising:
i) at least about 5% by weight of a cetyl pyridinium chloride; and
ii) at least about 25% to about 50% by weight of a copper sulfate biocide; and
iii) at least about 45% by weight of a pH buffer agent; and
b) at least about 0.1% to about 2% by weight of a polyethylene glycol base; and
c) from about 0.1% to about 4% by weight of a xanthan gum; and
d) the balance being an aqueous based carrier.

45. A composition for improving lameness in a domesticated animal comprising:
a) from about 0.05% to about 12% by weight of a biocidal system comprising:
i) at least about 5% by weight of a cetyl pyridinium chloride; and
ii) at least about 5% by weight of a zinc chloride biocide; and
iii) at least about 90% by weight of a pH buffer agent; and
b) at least about 0.1% to about 2% by weight of a polyethylene glycol base; and
c) from about 0.1% to about 4% by weight of a xanthan gum; and
d) the balance being an aqueous based carrier.

46. A composition for improving lameness in a domesticated animal comprising:
a) from about 0.05% to about 12% by weight of a biocidal system comprising:
i) at least about 5% by weight of a cetyl pyridinium chloride; and
ii) at least about 5% by weight of a copper chloride biocide; and
iii) at least about 90% by weight of a pH buffer agent; and
b) at least about 0.1% to about 2% by weight of a polyethylene glycol base; and
c) from about 0.1% to about 4% by weight of a xanthan gum; and
d) the balance being an aqueous based carrier.

47. A composition for improving lameness in a domesticated animal comprising:
a) from about 0.05% to about 12% by weight of a biocidal system comprising:
i) at least about 5% by weight of a cetyl pyridinium chloride; and
ii) at least about 5% by weight of a zinc sulfate biocide; and
iii) at least about 90% by weight of a pH buffer agent; and
b) at least about 0.1% to about 2% by weight of a polyethylene glycol base; and
c) from about 0.1% to about 4% by weight of a xanthan gum; and
d) the balance being an aqueous based carrier.

48. A composition for improving lameness in a domesticated animal comprising:
a) from about 0.05% to about 12% by weight of a biocidal system comprising:
i) at least about 5% by weight of a cetyl pyridinium chloride; and
ii) at least about 5% by weight of a copper sulfate biocide; and
iii) at least about 90% by weight of a pH buffer agent; and
b) at least about 0.1% to about 2% by weight of a polyethylene glycol base; and
c) from about 0.1% to about 4% by weight of a xanthan gum; and
d) the balance being an aqueous based carrier.

49. A method of improving lameness in domesticated animals comprising:
applying a composition comprising from about 0.05% to about 12.0% by weight of a biocidal system;
wherein said biocidal system comprising at least about 5% by weight of a primary biocide; and at least about 5% by weight of a secondary biocide, and at least 45% by weight of a pH buffer component to an infected area.

50. The method of claim 49 wherein the composition is applied in a foot bath.

51. The method of claim 49 wherein the composition is applied as a gel.

52. The method of claim 49 wherein the composition is applied as a wrap.

53. The method of claim 49 wherein the composition is applied as a foam.
